(19) United States
(12) Patent Application Publication
(10) Pub. No.: US 2002/0104242 A1
(43) Pub. Date: Aug. 8, 2002

(54) Flagger traffic control apparatus

(76) Inventor: Kermit Haugen, Graham, WA (US)

Correspondence Address: LAW OFFICE OF DAVID L. TINGEY, 321 BURNETT AVE. S., STE 303, RENTON, WA, 98055, US

(21) Appl. No.: 09/778,632

(22) Filed: Feb. 8, 2001

(51) Int. Cl. G09F 15/00; G09F 21/02; G09F 1/00

(52) U.S. Cl. 40/606; 40/586; 40/612

(57) ABSTRACT

A flagger traffic control apparatus comprises a standard with a pyramidal umbrella mounted on the standard top end as one or more display panels with traffic control indicia thereon, typically traditional stop and slow signs. Because the display umbrella is large, it also offers protection to the flagger from sun and rain. A transceiver is mounted on the standard so a flagger holding the standard can continue to manage the sign apparatus while speaking into and hearing the transceiver hands-free. A second display panel, typically similar to the traditional flagger sign with “stop” indicia on one side projecting in concert with an umbrella panel with “stop” indicia, is mounted intermediate the standard. A third display panel, similar to the second display panel, may also be mounted on the standard orthogonal to the second display panel. A light, typically stroboscopic or flashing, on the top of the umbrella also aids is attracting the attention of the oncoming traffic. At least one additional light may also be mounted on the standard.

### BACKGROUND OF THE INVENTION

1. Field of the Invention

The present invention relates to vehicle traffic control, and more specifically to an improved flagger sign and communication apparatus.

2. Description of the Prior Art

It is well-known to have flaggers at a road construction or improvement site for traffic control. Commonly, traffic is allowed one way through a single lane for a brief period. Traffic is then stopped by the flaggers, and traffic is allowed to pass through the lane in the opposite direction. As required by change in conditions during the construction period, flaggers change location along the road. Thus, equipment used by the flaggers for traffic control is necessarily also mobile.

Flaggers maintain the necessary traffic control by use of a sign on the top of a staff. The sign typically has a traditional stop sign indicia on one side and a traditional slow sign indicia on the other side. The flaggers often communicate with each other at opposite ends of the limited passage traffic lane by means of transceivers, which may be mobile telephones or radios.

With the flaggers alongside the traffic lane, the flaggers are in constant danger of being hit by approaching traffic. The danger is exacerbated by a driver's difficulty in seeing the flagger. The flagger using only the stop sign may not be seen or seen early enough for safe speed reduction and negotiation through the construction area. The flaggers also may be distracted or the control sign display may be compromised by the flagger having to use one or both hands to operate the transceiver as he coordinates traffic control with another flagger.

Safety and general flagger operation would be improved by a flagger sign that is more visible to oncoming traffic together with a transceiver integral with the sign that allows usage without requiring the flagger to release the sign to operate the transceiver.

### SUMMARY OF THE INVENTION

It is therefore an object of the present invention to provide an apparatus that will allow improved visibility of the flagger and his control sign together with a transceiver integral with the control sign for hands-free operation. Typically, the apparatus is used in combination with a like apparatus used by a second flagger, each flagger on opposite ends of a traffic control area.

This object is achieved in a flagger traffic control apparatus comprising a standard with a pyramidal umbrella mounted on the standard top end. Triangular sides of the umbrella comprise display panels on which are presented retroreflective traffic control indicia contrasting with panel backgrounds, typically traditional stop sign on one side and a traditional slow sign on the opposite panel. Alternately, the umbrella may comprise traditional stop signs on 2 opposing panels and slow signs on the other 2 opposing panels so that when the umbrella is rotated 180 degrees in the first embodiment and 90 degrees in the alternative embodiment, the panel changes from a display of a hexagonal “stop” sign to display of a “slow” sign, for example. Further rotation changes the display again to a “stop” sign. The apparatus may also be used for pedestrian crossings near schools by cross guards, in which case the “slow” indicia would instead be “walk” where the “stop” indicia is directed to approaching vehicle traffic while the “walk” indicia is directed to pedestrians.

The umbrella is also large and higher than a typical stop sign enabling it to be seen from a distance greater than would the typical stop sign. An added benefit of the large display umbrella is that it also offers protection to the flagger from sun and rain.

A transceiver is mounted on the standard so a flagger holding the standard can continue to manage the sign apparatus while speaking into and hearing the transceiver hands-free. The transceiver may be either a radio or telephone or any other suitable communication device.

A second display panel, typically similar to the traditional flagger sign with “stop” indicia on a first side projecting in concert with the “stop” panel of the umbrella, is mounted intermediate the standard. A “slow” sign is on a second side opposite the first.

A third display panel, similar to the second display panel, also may mounted in the first embodiment on the standard orthogonal to the second display panel and presenting “slow” indicia in concert with the second opposing umbrella display panels such that when the standard is rotated 90 degrees, the third display panel moves from not being visible in favor of the second display panel to being fully visible as the second display panel becomes not visible.

A light, typically red and flashing, on the top of the umbrella also aids is attracting the attention of the oncoming traffic.

### BRIEF DESCRIPTION OF THE DRAWINGS

FIG. 1 is a front perspective view of the flagger apparatus.

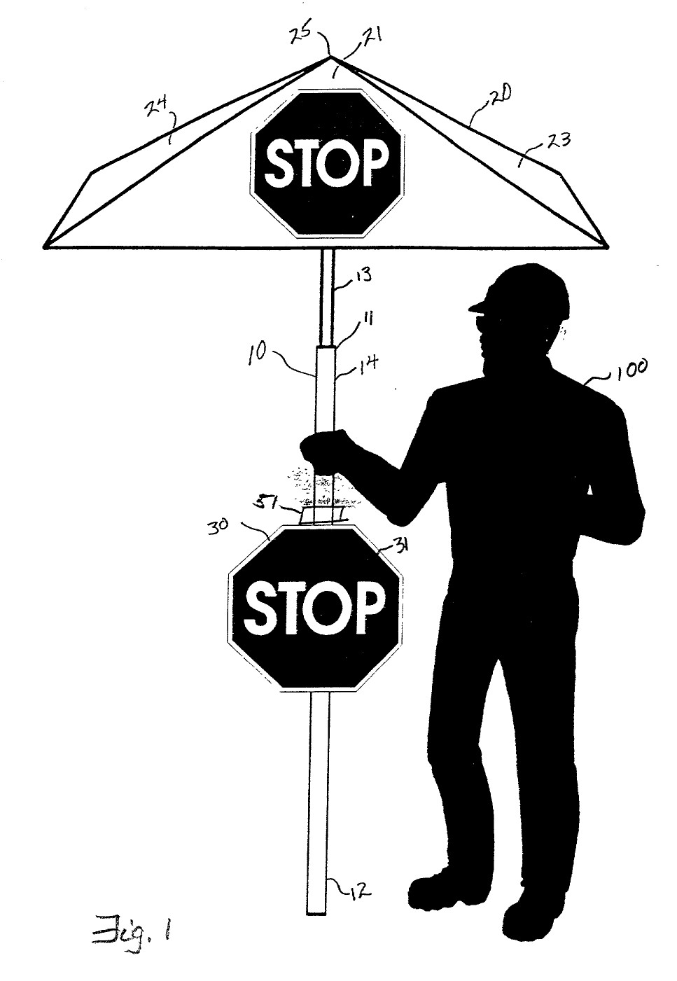

FIG. 2 is a perspective view of the apparatus of FIG. 1, rotated 90 degrees.

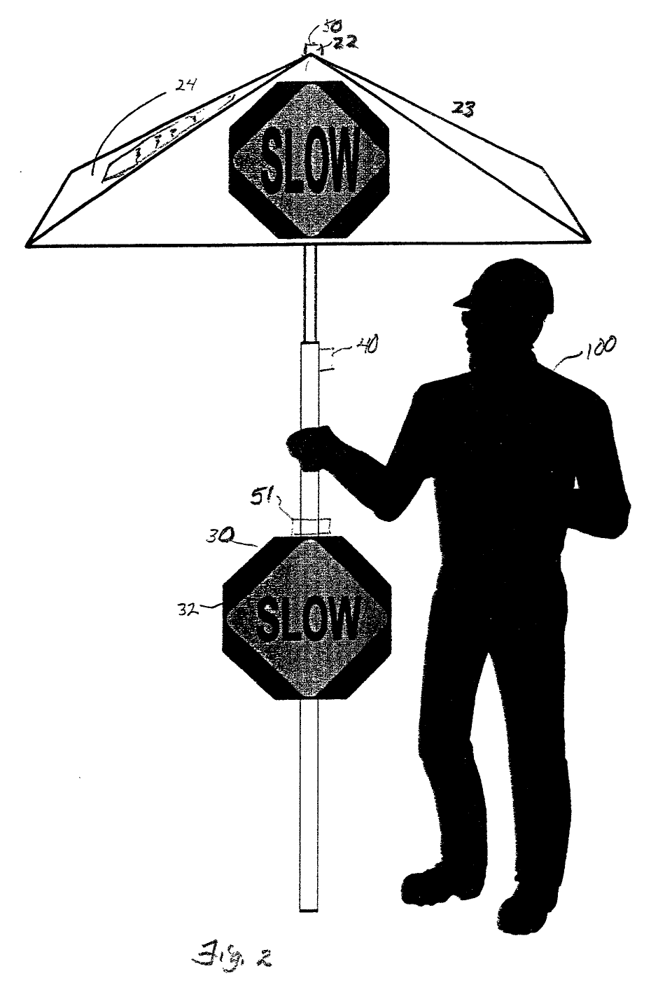

FIG. 3 shows the apparatus with “WALK” indicia instead of “SLOW” indicia as may be used by school cross guards

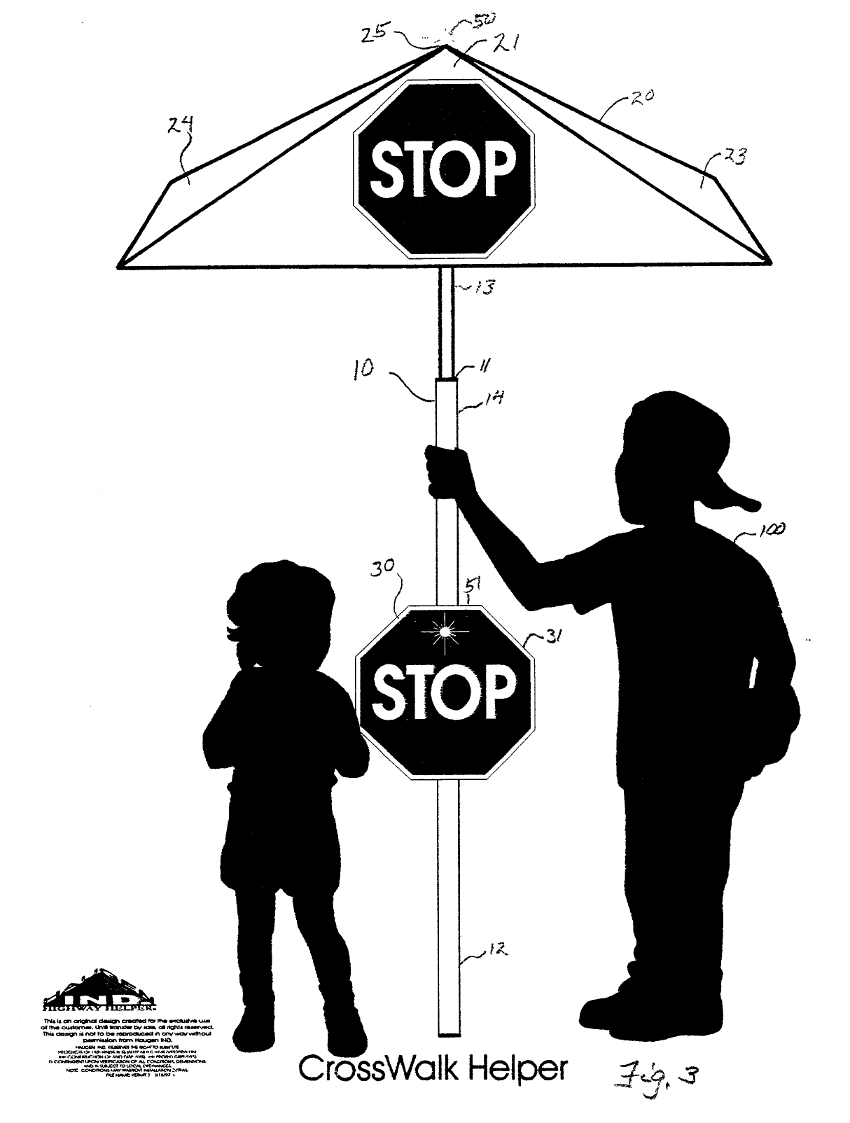

FIG. 4 is a perspective view of the apparatus of FIG. 3, rotated 90 degrees.

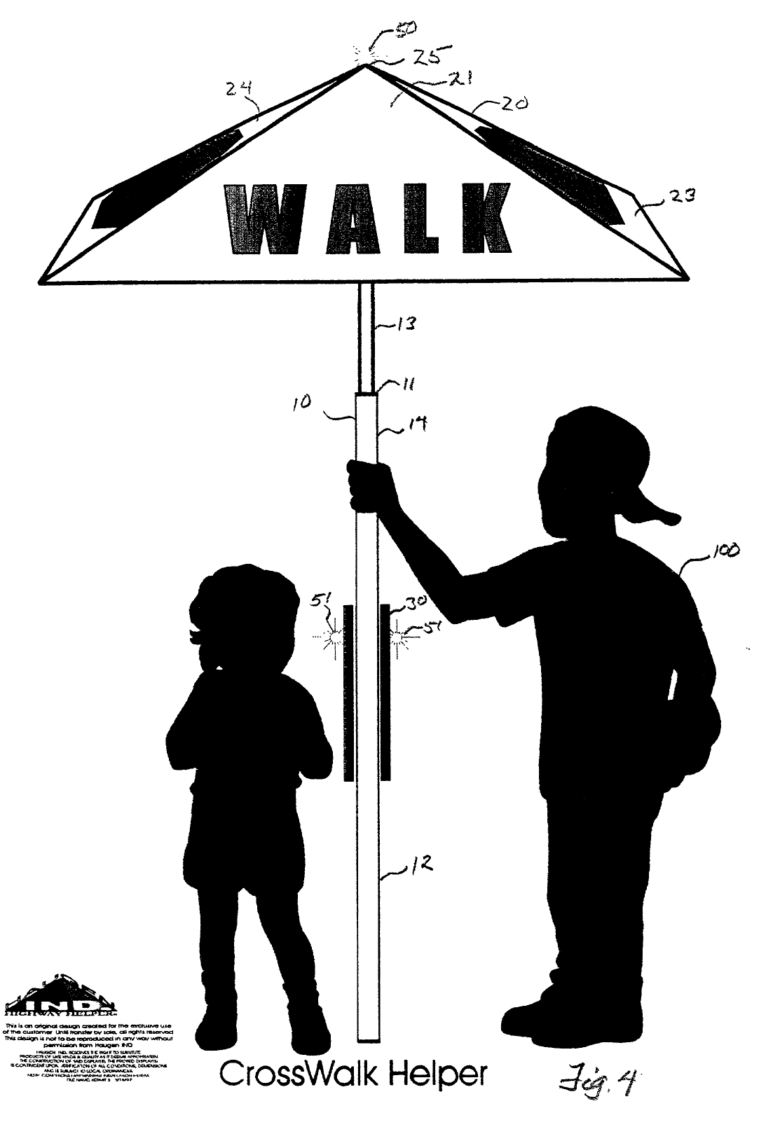

### DETAILED DESCRIPTION OF THE PREFERRED EMBODIMENT

The flagger control apparatus of the present invention comprises a standard 10 with top and bottom ends 11 and 12. The standard may include a second elongate member 13 telescoping from a first elongate member 14. A pyramidal umbrella 20 mounted on the standard top end 11 as a first display panel includes four flat triangular display panels, 21, 22, 23, 24 joined at a umbrella apex 25 comprising first set of opposing panels 21 and 22 and second set of opposing panels 23 and 24 each with a base, the bases together forming a rectangular umbrella base, advantageous as communicating display panels as well as traditional umbrella protecting a user from rain.

In a first embodiment, a traditional “stop” sign is on one of the panels of the first set, 21, with a traditional “slow” sign on the other, 22. The panels of the second set are adapted as general display panels, such as for conveying other messages or advertising.

In a second embodiment, at least one of the first set of opposing panels 21, 22 has traffic control indicia thereon, such as an outline of a traditional “stop” sign. At least one panel of the second set of opposing panels 23, 24 also has traffic control indicia thereon but different from that on the first set of panels, such as an outline of a traditional “slow” sign. Alternatively, “walk” indicia may be used instead of “slow” indicia for use by crossing guards near school pedestrian crossings.

Display indicia on the umbrella display panels are elongated by a factor equal to the cosecant of the angle of inclination of the umbrellas panels from horizontal such that the indicia on the inclined umbrella panels project traditional “stop” and “slow” signs, and equivalently other indicia, to the horizontal. The indicia are formed from a retroreflective material, typically comprising an array of microscopic corners opening outward such that incident light emerges parallel but opposite its direction of incidence.

A second display panel 30 is mounted intermediate the standard ends and oriented in a same direction with the first display panel and having a front side with indicia relating to traffic control thereon similar to the indicia on the umbrella first set of display panels. Typically, the standard passes through the second display panel such that the “stop” display is visible on a “stop” side 31 of the standard, and the “slow” display is visible on a “slow” side 32 of the standard.

A third display panel 35 may be mounted orthogonal to the second display panel also intermediate the standard ends and oriented in a same direction with the second display panel and having a front side with indicia relating to traffic control thereon similar to the indicia on the umbrella first set of display panels and therefore also different from that indicia on the second display panel.

A transceiver 40 is mounted on the standard intermediate its ends adapted for use by a flagger 100 without requiring the flagger to independently hold the transceiver, thus freeing the flagger to concentrate on managing the control apparatus. Typically, the control apparatus is used by a flagger in combination with a second flagger also equipped with a control apparatus, the flaggers on opposite ends of a traffic control area with the flaggers intercommunicating by means of the transceivers.

A first light 50, typically stroboscopic or flashing, is mounted to the umbrella apex 25 to attract attention of approaching vehicle drivers. Similarly, a second light 51 is mounted on or near the second display on the standard “stop” side 31.

Having described the invention, what is claimed is as follows:

1. A flagger control sign apparatus for traffic control at a roadway, comprising
a standard with top and bottom ends rotatable on its bottom end,
a first display panel at the standard top end,
a second display panel intermediate the standard ends and oriented in a same direction with the first display panel and having a front side which includes indicia relating to traffic control thereon,
said standard rotatable on its bottom end between a first position with the display panel indicia maximally visible to a second position with the display panel indicia invisible or minimally visible.

2. The apparatus of claim 1 wherein said standard comprises a second elongate member telescoping from a first elongate member.

3. The apparatus of claim 1 further comprising a transceiver mounted on the standard for hands-free transceiver operation.

4. The apparatus of claim 1 wherein the first display panel further comprises an umbrella including at least one flat display panel inclined at an angle if inclination from horizontal.

5. The apparatus of claim 4 wherein said umbrella comprises a 4-sided pyramidal structure with an apex and including first and second sets each of 2 opposing flat panels each panel including a base, the bases of the 4 panels together forming a rectangular umbrella base, the standard depending from the apex through the base, and each panel inclined at said angle if inclination from horizontal.

6. The apparatus of claim 5 wherein at least one panel includes a first indicia relating to traffic control and at least one other panel includes a second indicia relating to traffic control different from the first indicia.

7. The apparatus of claim 6 wherein said indicia are elongated by a factor equal to the cosecant of the angle of inclination such that the indicia on the inclined umbrella panels project traditional “stop” and “slow” signs, to the horizontal.

8. The apparatus of claim 5 wherein said indicia on said second display panel is the same as said indicia on said first indicia.

9. The apparatus of claim 5 wherein said indicia comprises retroreflective material such that light incident on the indicia emerges from the panel parallel to but opposite its direction of incidence.

10. The apparatus of claim 5 wherein the standard is rotatable on its bottom end such that from a given observation position distant from the structure, the umbrella panels project alternating displays from the umbrella as the umbrella rotates with the rotatable standard.

11. The apparatus of claim 1 in combination with a light on top of the umbrella apex.

12. The apparatus of claim 1 in combination with at least one light on the standard.

13. The apparatus of claim 1 in combination with a transceiver mounted on the standard adapted for hand-free operation.

14. The apparatus of claim 12 in combination with a second apparatus of claim 10 with the transceivers in mutual communication.

15. The apparatus of claim 1 further comprising a third display panel mounted on the standard orthogonal to the second display panel intermediate the standard ends and oriented in a same direction with the second display panel, the panel having a front side which includes indicia relating to traffic control thereon different from that indicia on the second display panel.
